(19) United States
(12) Patent Application Publication
(10) Pub. No.: US 2026/0267083 A1
(43) Pub. Date: Sep. 10, 2026

(54) CONNECTOR HAVING PULL-TO-RELEASE DETERRENT

(71) Applicant: The Siemon Company, Watertown, CT (US)

(72) Inventors: Robert Stuart Carlson, Burlington, CT (US); John Corsi, Sandy Hook, CT (US)

(21) Appl. No.: 19/560,692

(22) Filed: Mar. 9, 2026

Related U.S. Application Data
(60) Provisional application No. 63/769,402, filed on Mar. 10, 2025.

(51) Int. Cl. G02B 6/38

(52) U.S. Cl. CPC G02B 6/3893; G02B 6/3895

(57) ABSTRACT

A connector includes a connector interface to mate the connector with a receptacle; a latching mechanism including a latching element and a pull-to-release housing; a pull-to-release deterrent positioned adjacent to the pull-to-release housing, the pull-to-release deterrent increasing the force required to move the pull-to-release housing away from the connector interface, the pull-to-release deterrent not preventing movement of the pull-to-release housing away from the connector interface.

### CROSS-REFERENCE TO RELATED APPLICATIONS

This application claims the benefit of Provisional Application No. 63/769,402 filed Mar. 10, 2025, the disclosure of which is incorporated herein by reference in its entirety.

### BACKGROUND

The embodiments described herein relate generally to connectors, and more particularly to optical fiber connectors having a pull-to-release deterrent.

There are many different types of optical fiber connectors. A multi-fiber push on (MPO) connector is a type of optical fiber connector that is commonly used in high-speed telecom and data communications networks. MPO connectors generally include a latching mechanism to maintain a connection between the MPO connector and an optical module. Easy-release of the MPO connector from the optical module may be implemented using a pull-to-release housing.

When users are supplied with cable assemblies made up of a MPO cable assembly, pre-installed into an optical module (e.g., a transceiver), the connection between the MPO connector and the optical module has been made in a clean environment and tested once connected. A user unaware of this may, in the process of moves/adds/changes, remove the MPO connector from the optical module rather than removing the optical module from the active equipment (e.g., by using a pull tab on the optical module). Removing the MPO connector from the optical module can introduce dust/debris into the optical module receptacle or the MPO connector end face, reducing performance and causing network issues.

There is risk when removing the MPO connector from the optical module as this will only present a chance for debris/dust/contaminants to enter the port or contaminating the MPO connector end face and reducing optical performance. The connection between the MPO connector and the optical module is factory tested. Disconnection and reconnection can affect insertion loss and return loss in the mated connections that can affect product/network performance and void the factory warranty. Some existing MPO connectors are equipped with a lock so that the MPO connector is prevented from being removed from an optical module. At times, users are unaware of the lock and will apply extreme force to remove the MPO connector from the optical module. This can result in damage to one or both of the MPO connector and the optical module.

### SUMMARY

According to an embodiment, a connector includes a connector interface to mate the connector with a receptacle; a latching mechanism including a latching element and a pull-to-release housing; a pull-to-release deterrent positioned adjacent to the pull-to-release housing, the pull-to-release deterrent increasing the force required to move the pull-to-release housing away from the connector interface, the pull-to-release deterrent not preventing movement of the pull-to-release housing away from the connector interface.

In addition to one or more of the features described herein, or as an alternative, further embodiments may include a body supporting the pull-to-release housing; a boot adjacent to the main body; a slot provided between the boot and the pull-to-release housing; the pull-to-release deterrent located in the slot.

In addition to one or more of the features described herein, or as an alternative, further embodiments may include wherein the pull-to-release deterrent is an o-ring.

In addition to one or more of the features described herein, or as an alternative, further embodiments may include wherein the o-ring has a cross section that is round, oval or rectangular.

In addition to one or more of the features described herein, or as an alternative, further embodiments may include wherein the pull-to-release deterrent is made from a flexible, compressible material.

In addition to one or more of the features described herein, or as an alternative, further embodiments may include wherein the connector is an MPO connector.

In addition to one or more of the features described herein, or as an alternative, further embodiments may include wherein the pull-to-release deterrent is colored to make the pull-to-release deterrent readily distinguishable from the MPO connector and pull-to-release housing.

In addition to one or more of the features described herein, or as an alternative, further embodiments may include an anti-tamper sticker affixed to any portion or combination of the pull-to-release housing, the pull-to-release deterrent or the connector body.

In addition to one or more of the features described herein, or as an alternative, further embodiments may include wherein the connector is an optical fiber connector.

In addition to one or more of the features described herein, or as an alternative, further embodiments may include wherein the pull-to-release deterrent comprises a material that discolors when stressed or flexed to provide visual evidence of tampering.

In addition to one or more of the features described herein, or as an alternative, further embodiments may include wherein the pull-to-release deterrent comprises one or more notches or one or more textures to facilitate removal.

In addition to one or more of the features described herein, or as an alternative, further embodiments may include a label or tab configured to serve as a grip point when releasing the connector from the receptacle.

According to another embodiment, a method of assembling a connector includes terminating a cable to the connector; mating a connector interface of the connector with the receptacle; placing a pull-to-release deterrent adjacent to the pull-to-release housing, the pull-to-release deterrent increasing the force required to move the pull-to-release housing away from the connector interface.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 depicts a connector and pull-to-release deterrent in an example embodiment.

FIG. 2 depicts a connector with a pull-to-release deterrent, the connector mated with an optical module in an example embodiment.

FIG. 3 is an enlarged view of the connector with the pull-to-release deterrent in an example embodiment.

### DETAILED DESCRIPTION

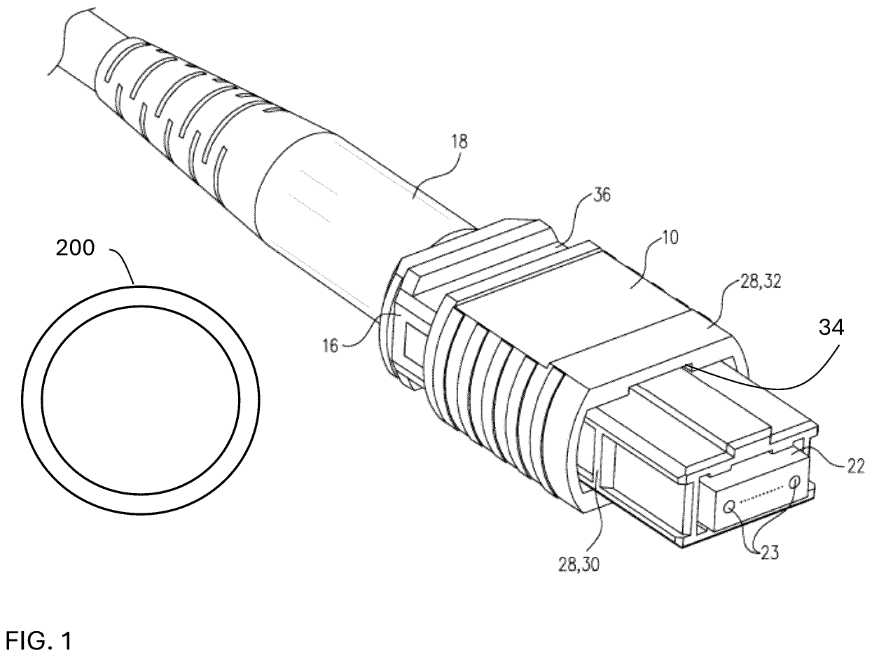

FIG. 1 depicts a connector 10 and a pull-to-release deterrent 200 in an example embodiment. The connector 10 provides a bend-not-break functionality to allow unmating of the connector 10, but with increased resistance to deter unmating. The connector 10 may be an optical fiber connector, such as an MPO connector. The MPO connector 10 may include a latching mechanism 28 to maintain connection between the MPO connector 10 and a receptacle, such as an interface of an optical module. Easy-release of the MPO connector 10 from the optical module may be implemented using a pull-to-release housing 32, as known in the art.

The MPO connector 10 includes a body 16. The body 16 includes a boot 18 configured to accept an optical fiber therein, and a connector interface 22, which may include alignment pins or holes 23, configured to be reversibly connected to an MPO interface of a receptacle, such as an optical module.

The latching mechanism 28 includes latching elements 30 and the pull-to-release housing 32, which optionally may be spring-loaded. The latching elements 30 with the pull-to-release housing 32 are configured to latch the connector interface 22 of the MPO connector 10 with the MPO interface of the optical module, as is known in the art.

The latching elements 30 are typically protrusions at the side of the body 16. Inserting the connector interface 22 of the MPO connector 10 into the MPO interface of the optical module typically causes the latching elements 30 to engage with spring-loaded latches of the optical module. The pull-to-release housing 32 is configured to rest against the MPO interface of the optical module around latches of the MPO interface of the optical module thereby preventing release of the latches from around the latching elements 30 and thereby latching the connector interface 22 of the MPO connector 10 with the MPO interface of the optical module preventing release of the MPO connector 10 from the optical module.

The pull-to-release housing 32 is configured to expose the latching elements 30, upon retraction of the pull-to-release housing 32 away from the connector interface 22 and towards the boot 18, thereby allowing the latches to release and allow removal of the MPO connector 10 from the optical module. The MPO connector 10 includes an elongated channel 34 having sides, a top, and a bottom. The sides and top are defined by the pull-to-release housing 32, and the bottom is defined by the body 16. The pull-to-release housing 32 and the body 16 define a slot 36 therebetween in which to retract the pull-to-release housing 32. The slot 36 may be provided on a top side and a bottom side of the body 16.

FIG. 1 also depicts a pull-to-release deterrent 200. The pull-to-release deterrent 200 may be ring shaped and may be made from a flexible, compressible material such as nitrile (Buna), neoprene, ethylene propylene diene monomer (EPDM), silicone, fluorocarbon (Viton), PTFE (Teflon), polyurethane, hydrogenated nitrile (HNBR), or polyacrylate (ACM). The pull-to-release deterrent 200 may be similar to an o-ring. The pull-to-release deterrent 200 is installed in the slot 36 of the optical fiber connector 10 to deter sliding the pull-to-release housing 32 away from the connector interface 22 and towards the boot 18. If enough force is applied, the pull-to-release housing 32 will compress the pull-to-release deterrent 200 allowing the pull-to-release housing 32 to move away from the connector interface 22 and towards the boot 18 to release the latching mechanism 28. The pull-to-release deterrent 200 increases the force required to move the pull-to-release housing 32 away from the connector interface 22 as opposed to connectors lacking the pull-to-release deterrent 200. The pull-to-release deterrent 200 does not prevent movement of the pull-to-release housing 32 away from the connector interface 22 and towards the boot 18.

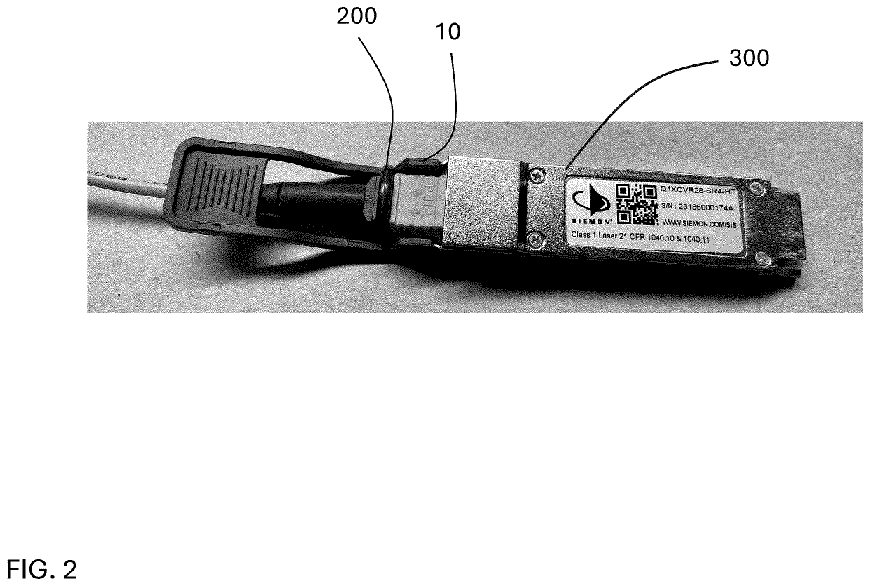

FIG. 2 depicts a connector 10 with a pull-to-release deterrent 200 mated with an optical module 300 in an example embodiment. In FIG. 2, the optical module 300 is an optical transceiver. While FIG. 2 shows the connector 10 mated with an optical module 300, embodiments are not limited by the component that the connector 10 engages. Embodiments of the connector 10 may be used with any receptacle configured to receive the connector 10.

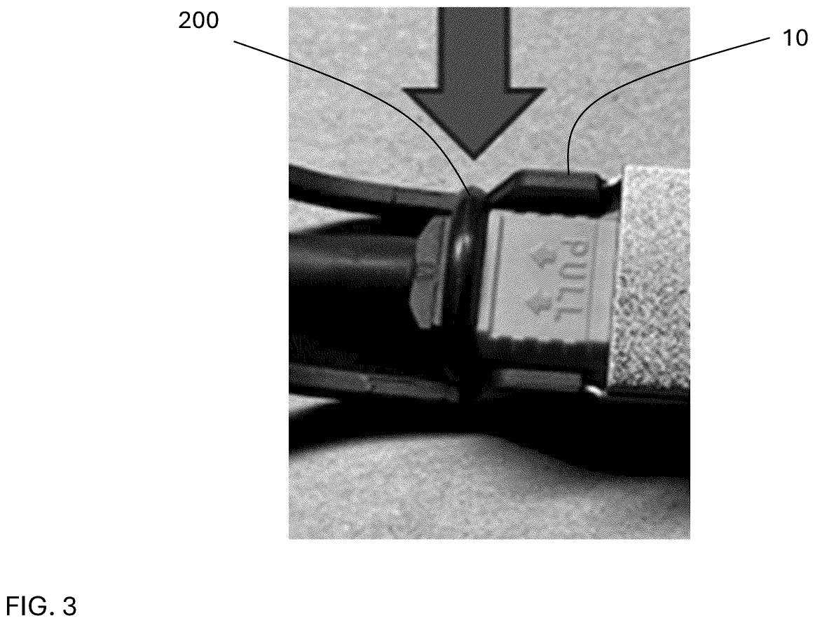

FIG. 3 is an enlarged view of the connector 10 with the pull-to-release deterrent 200 in an example embodiment.

When the connector 10 and the optical module 300 are assembled in the factory, the pull-to-release deterrent 200 would be placed over the connector 10 and rolled back behind the connector 10 around the boot 18. All necessary cleaning of the receptacle of the optical module 300 and connector 10 would be carried out as needed. The connector 10 would then be installed into the receptacle of the optical module 300. Any required testing would be carried out. The pull-to-release deterrent 200 would then be rolled into place and would drop into the slot 36 behind the pull-to-release housing 32. The pull-to-release deterrent 200 makes it more difficult, but requires intent, to release the connector 10 from the receptacle of the optical module 300. Since the pull-to-release deterrent 200 is made of a flexible, compressible material, if force is applied to the pull-to-release deterrent 200 (e.g., a user isn't aware of the presence of the pull-to-release deterrent 200) the pull-to-release deterrent 200 will flatten in the slot 36 and allow movement of the pull-to-release housing 32, but at a higher than usual force. This higher force will either act as a deterrent, but if not and additional force is applied, the pull-to-release deterrent 200 will flex further until the pull-to-release housing 32 has moved back far enough to allow the connector 10 to be released from the receptacle of the optical module 300. The pull-to-release deterrent 200 is compressed between the body 16 and the pull-to-release housing 32. No damage will be caused to the connector 10 or optical module 300 as a result. The pull-to-release deterrent 200 can be rolled out of the slot 36 and towards boot 18 for removal and be re-used if necessary (e.g., in the field).

The pull-to-release deterrent 200 may be installed in the slot 36 at the factory prior to cable termination to the connector 10 or after cable termination to the connector 10 (e.g., at the factory or in the field). The durometer, the cross section and shape of the pull-to-release deterrent 200 are selected to provide both (i) the deterrent force to un-mate the connector 10 from the optical module 300 and (ii) a desired level of difficulty to remove the pull-to-release deterrent 200 from the connector body 16. A cross section of the pull-to-release deterrent 200 may be round, oval or rectangular.

The pull-to-release deterrent 200 may be made from a material that discolors when stressed or flexed, which provides visual evidence of tampering. The pull-to-release deterrent 200 and/or the connector body 16 may include one or more notches and/or one or more textures to enable removal of the pull-to-release deterrent 200 by hand (e.g., rolling motion) or with a tool.

The connector 10 may include a label or a tab providing for identification and/or removal of the connector 10 from the optical module 300. The label or tab may be large enough to support indicia identifying the connector 10 and/or optical module 300. The label or tab may be large enough to serve as a grip point when releasing the connector 10 from the optical module 300.

The pull-to-release deterrent 200 may be colored to make the pull-to-release deterrent 200 more visible to users and to make the pull-to-release deterrent 200 readily distinguishable from the MPO connector 10 and the pull-to-release housing 32 of the MPO connector 10. The pull-to-release deterrent 200 may be colored to identify a type of circuit routed through the connector 10. The pull-to-release deterrent 200 may be used in conjunction with an anti-tamper sticker affixed to the pull-to-release housing 32. If the pull-to-release housing 32 has moved back far enough to allow the connector 10 to be released from the receptacle of the optical module 300, the anti-tamper sticker will be visibly deformed, discolored or ripped. This indicates a potential risk of contamination and/or potential performance issues. The anti-tamper sticker may be affixed to any portion, or combination of, the pull-to-release housing 32, the pull-to-release deterrent 200 and/or the connector body 16.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A connector comprising:
a connector interface to mate the connector with a receptacle;
a latching mechanism including a latching element and a pull-to-release housing;
a pull-to-release deterrent positioned adjacent to the pull-to-release housing, the pull-to-release deterrent increasing the force required to move the pull-to-release housing away from the connector interface,
the pull-to-release deterrent not preventing movement of the pull-to-release housing away from the connector interface.

2. The connector of claim 1 further comprising:
a body supporting the pull-to-release housing;
a boot adjacent to the main body;
a slot provided between the boot and the pull-to-release housing;
the pull-to-release deterrent located in the slot.

3. The connector of claim 1 wherein the pull-to-release deterrent is an o-ring.

4. The connector of claim 3 wherein the o-ring has a cross section that is round, oval or rectangular.

5. The connector of claim 1 wherein the pull-to-release deterrent is made from a flexible, compressible material.

6. The connector of claim 1 wherein the connector is an MPO connector.

7. The connector of claim 1 wherein the pull-to-release deterrent is colored to make the pull-to-release deterrent readily distinguishable from the MPO connector and pull-to-release housing.

8. The connector of claim 1 further comprising an anti-tamper sticker affixed to any portion or combination of the pull-to-release housing, the pull-to-release deterrent or the connector body.

9. The connector of claim 1 wherein the connector is an optical fiber connector.

10. The connector of claim 1 wherein the pull-to-release deterrent comprises a material that discolors when stressed or flexed to provide visual evidence of tampering.

11. The connector of claim 1 wherein the pull-to-release deterrent comprises one or more notches or one or more textures to facilitate removal.

12. The connector of claim 1 further comprising a label or tab configured to serve as a grip point when releasing the connector from the receptacle.

13. A method of assembling a connector and a receptacle, the method comprising:
terminating a cable to the connector;
mating a connector interface of the connector with the receptacle;
placing a pull-to-release deterrent adjacent to the pull-to-release housing, the pull-to-release deterrent increasing the force required to move the pull-to-release housing away from the connector interface.
